(19) United States
(12) Patent Application Publication
(10) Pub. No.: US 2007/0042883 A1
(43) Pub. Date: Feb. 22, 2007

(54) Non-dusting roll for tft glass

(75) Inventors: Alan Daily, Darlington, PA (US); Mark Hall, New Castle, PA (US); John Dodsworth, Beaver Falls, PA (US); Dale Hoggard, Pittsburgh, PA (US); Dwayne Bucko, Sewickley, PA (US)

Correspondence Address: JAMES R. WILLIAMS, 3103 WILMINGTON ROAD, NEW CASTLE, PA, 16105, US

(73) Assignee: Vesuvius Crucible Company, Wilmington, DE (US)

(21) Appl. No.: 10/572,712

(22) PCT Filed: Oct. 6, 2004
(86) PCT No.: PCT/US04/32830

§ 371 Date: Oct. 25, 2006

Related U.S. Application Data
(60) Provisional application No. 60/512,808, filed on Oct. 20, 2003.
(60) Provisional application No. 60/542,428, filed on Feb. 6, 2004.

(51) Int. Cl. F16C 13/00

(52) U.S. Cl. 492/40; 492/50

(57) ABSTRACT

A refractory roll cover is described that reduces the amount of noxious dust during the production of glass sheet. The roll cover comprises a plurality of segments, including low dusting millboard segments mechanically supported by highly rigidized compressed fiber segments. The millboard segments are adapted to contact the glass sheet. The millboard is chosen so that any dust produced has little affinity for the glass sheet or is not easily fluidized by convective currents. The highly rigidized compressed fiber has a fused surface that releases little dust. The resultant roll cover substantially eliminates dusting while providing a mechanically superior roll cover.

### FIELD OF THE INVENTION

The invention relates to a roll for the production of sheet glass by the down-draw glass fusion process and, in particular, to a pulling roll for use in the production of glass for active matrix display thin film transistor applications.

### BACKGROUND OF THE INVENTION

Sheet glass production typically requires the use of a refractory covered roll. In the past, the refractory cover often included asbestos fiber as disclosed in, for example, U.S. Pat. No. 1,594,417 to Kobbe, U.S. Pat. No. 1,678,345 to Mattison and U.S. Pat. No. 3,334,010 to Moore. Asbestos is a known health hazard and refractory covers no longer include asbestos. Other natural fibrous minerals such as wollansotonite and synthetic fibers of ceramic or glass have been used in place of asbestos. Clay-based compositions may also be used. Compositions including clay are sometimes referred to as millboard. For example, U.S. Pat. No. 4,487,631 to Britt teaches a refractory cover comprising millboard, specifically glass fiber and clay. U.S. Pat. No. 5,378,219 to Hart teaches a compressed ceramic fiber for use as a roll cover. Compressed fiber roll covers are preferably saturated with a colloidal rigidizer and dried to produce mechanically stable roll covers. Each type of roll cover often comprises a plurality of segments stacked on a metal mandrel.

Asbestos-free refractory rolls can “dust” during use. “Dusting” includes the release of small particles or fibers from the roll during use and particularly such particles and fibers that are easily transported via convective currents. Certain types of dust can stick to the glass sheet as the sheet passes over the roll. The dust can thereby cause microscopic defects in the glass. Glass for use in thin film transistor (TFT) applications must be substantially free of such defects, so dusting is very problematic in the production of TFT sheet glass. Even small imperfections in TFT glass, which is use in active matrix display screens, can disrupt the electronic grid placed on the glass.

A particular type of roll in glass production is a pulling roll, which pulls very thin sheets, such as TFT glass, from a forming block. Pulling rolls operate in tandem with the glass sheet moving between adjacent pulling rolls. Pulling rolls often comprise a profiled refractory cover over a metal shaft. The profile includes “pulling flats,” which typically are the only part of the roll cover that actually touches the glass sheet. The pulling flats contact the glass sheet along its outer edges and pull the glass sheet in a downward motion. Limiting contact with the glass sheet reduces damage to the glass sheet and generation of wear debris from the roll.

Both millboard-based and compressed fiber-based pulling rolls have dusting problems that affect the quality of glass sheet. Dust may or may not include fiber material. U.S. Pat. No. 4,487,631 to Britt suggests only unfiberized material can cause defects in the glass sheet. See col. 1, lines 41-43. The inventors have observed dust comprising colloidal particles and even, unlike Britt, colloidal particles in combination with fiber. The nature of the dust can depend on the method of dust evolution and the dust deposition mechanism. For example, dust can originate from simple wear or from mechanical shock, such as dropping of the glass on the roll. One dusting mechanism includes convective air currents carrying dust up the draw of the process. The convected dust deposits on the hot glass surface and becomes permanently fused to the glass sheet. Naturally, various other dust generation and deposition mechanisms can exist.

Prior art has developed a millboard roll cover that does not produce detrimental dust. The millboard includes mica, which resists convection and has a low affinity for silica. Unfortunately, the thermal instability of millboard rolls often leads to high temperature performance issues, such as separation of adjacent millboard segments and consequential wear.

A need exists for a refractory roll cover that produces few dusting problems, especially in high demand applications such as pulling rolls for TFT glass, while retaining good mechanical and thermal stability. The cover should not contain free silica particles or fibers that are easily transported in convective currents of glass forming mechanisms. The cover should also resist segment separation even after extended use at elevated temperature.

### SUMMARY OF THE INVENTION

The present invention describes a roll cover comprising segments of millboard and highly rigidized compressed fiber. The millboard is preferably low dusting or is chosen so that any dust produced is not prone to convective transfer or has little affinity for the glass sheet. The highly rigidized compressed fiber is mechanically strong and includes a fused surface that releases little, if any, dust. The roll cover is thereby produces little noxious dust, which adheres to glass sheet.

In a broad aspect, the roll cover synergistically combines the advantages of millboard and highly rigidized compressed fiber. Millboard may produce innocuous dust but typically is mechanically weak and friable. Highly rigidized compressed fiber is mechanically strong but may produce large quantities of noxious dust. The present invention adopts a configuration that combines millboard and highly rigidized compressed fiber segments in a low-dusting, mechanically strong roll cover.

In one embodiment, the roll cover comprises donut-shaped segments of refractory material adapted to fit over a metal mandrel. At least two segments comprise low dusting millboard and are adapted to contact, support and optionally pull a glass sheet. The remaining segments comprise highly rigidized compressed fiber and are adapted to mechanically support the millboard. The highly rigidized compressed fiber segments have been treated so that their surfaces are sufficiently hardened and produce little or no dusting.

In one aspect, the roll cover is adapted for use with a contoured pulling roll having a plurality of pulling flats. The pulling roll comprises a steel mandrel covered by at least two low dusting millboard segments and at least three highly rigidized compressed fiber segments. The millboard segments comprise the pulling flats, which extend in cross-section above the fiber segments. The fiber segments include a center segment and two outer segments. Each fiber segment may include a raised shoulder at its interface with the millboard segments. The millboard segments may have a complementary incline. The fiber segments are adapted not to contact a glass sheet while providing mechanical support for the millboard segments.

In another aspect, the roll cover includes pulling flats separated by a center segment comprising a refractory material. Compression rings on either end of the center segment maintain the fiber in compression during manufacture and use of the roll cover, thereby reducing the compressive forces on the pulling flats. In one embodiment, the compression ring comprises a snap ring adapted to fit into a recess in a mandrel on which the roll cover is installed.

### BREIF DESCRIPTION OF THE DRAWINGS

FIG. 1 shows a side view of a prior art contoured pulling roll.

FIG. 2 shows a side view of a contoured pulling roll of the present invention.

FIG. 3 shows an alternative embodiment of a contoured pulling roll of the present invention.

FIG. 4 shows another embodiment of a pulling roll including compression rings.

### DETAILED DESCRIPTION OF THE INVENTION

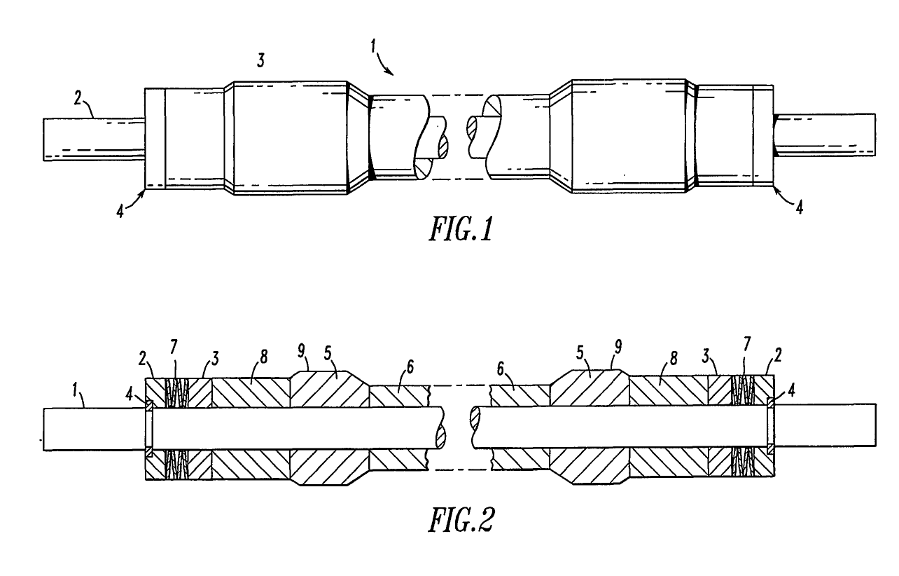

FIG. 1 shows a prior art roll 1 comprising a metal shaft 2 having an insulating cover 3. The insulating cover may comprise millboard or compressed fiber. The refractory cover 3 is contained within end plates 4. The metal shaft 2 is supported and may be internally cooled by means not shown. The support will normally permit rotational movement of the roll. Internal cooling is facilitated by a hollow shaft and the use of a cooling liquid. The end plates 4 maintain compression on the refractory cover 3, also by means not shown. Compression aids in maintaining mechanical integrity of the refractory cover. One skilled in the art would appreciate a number of end plates and caps adapted to maintain compression of the refractory cover.

The outer surface of the metal shaft 2 is substantially covered along the axial direction of the shaft 2 with a roll cover comprising a plurality of refractory segments. The segments are held compressively engaged by the end plates 4. Periodically, as the refractory cover “sets,” the end plates must be adjusted to maintain a compressive force on the segments. Conveniently, a spring may be used with the end plate so small amounts of “set” can be accommodated without manually adjusting the end plate.

Prior art roll covers have included either millboard or compressed fiber. Millboard is generally a clay-based product and may also include natural and synthetic minerals and fibers. Compressed fiber generally includes natural or synthetic ceramic fiber, such as silica, that is impregnated with a rigidizer. A common rigidizer is a colloidal suspension of a refractory oxide, such as colloidal silica or colloidal alumina. The impregnated fiber is then dried and optionally heated at elevated temperatures. The amount of impregnation, drying and heating all affect the ultimate hardness of a fiber roll cover. U.S. Pat. No. 5,378,219 to Hart, which is hereby incorporated by reference, explains various production methodologies and properties of compressed fiber roll covers.

Certain components, which are often present in both millboard and compressed fiber covers, have an affinity for glass sheet. Small particles of these components, that is “dust,” may adhere to hot glass sheet leaving microscopic imperfections. Millboard has been developed that produces dust with a low affinity for glass, hereafter known as “low dusting millboard.” Low dusting millboard typically lacks components that provide mechanical integrity to the millboard, such as ceramic fiber or fused silica particles. Components of low dusting millboard include flat or bonded particles that are not easily transported in convective currents, that is, the components tend to be non-aerodynamic. Unfortunately, low dusting millboards are brittle and friable. In contrast, highly rigidized compressed fiber consists essentially of ceramic fibers and fused silica particles. The fiber and fused silica combine to produce a mechanically stable roll cover. Both silica fiber and fused silica have a strong affinity for glass sheet.

The present invention combines the benefits of low dusting millboard and a highly rigidized compressed fiber while avoiding the limitations of both. The roll cover of the present invention includes a contacting portion and a rigid portion. The contacting portion is adapted to contact glass sheet and consists essentially of low dusting millboard. The rigid portion preferably would not contact glass sheet. Instead, the rigid portion mechanically supports the low dusting millboard, thereby substantially preventing the millboard from deforming. The rigid portion may include highly rigidized compressed fiber having at least a substantially fused surface. The fused surface limits dust formation and the creation of imperfections in glass sheet. In addition to a fused surface, the rigid portion may be fused throughout its volume.

The low dusting millboard can be any millboard that maintains its resilience to about 850 C and produces little or no dust with an affinity for glass sheet. The millboard must retain its shape and cannot degrade either chemically or physically under load and at operating temperatures. Additionally, the low dusting millboard must be resilient enough to reduce fracture of the glass sheet. One type of such millboard comprises clay and mica and contains little fiber or silica particles.

The rigid portion must also be able to withstand temperatures of at least 850 C. Conveniently, the rigid portion comprises highly rigidized compressed fiber with at least a fused surface. The fused surface releases little if any dust during operations but lacks the resilience necessary for direct contact with glass sheet. Highly rigidized compressed fiber is essentially incompressible and has excellent mechanical integrity. Sections of highly rigidized compressed fiber may even be reused as low dusting millboard sections wear and need replacement. A highly rigidized compressed fiber segment may be formed by saturating a compressed fiber section with a rigidizer, drying the saturated section, and heating the dried section at elevated temperatures. Heating fuses the rigidizer particles, thereby producing at least a substantially fused surface. Preferably, hearing occurs above about 1100 C.

FIG. 2 shows a pulling roll of the present invention. The pulling roll includes a shaft 1 and a refractory roll cover. In this embodiment, the pulling roll also includes two outer end plates 2 and two inner end plates 3 between which is a compression spring 7. The spring 7 helps maintain compression on the millboard sections 5 and improves mechanical wear of the millboard sections 5. Optionally, the outer end plates 2 may be split and a split ring 4 may be used to retain each outer end plate 2. The roll cover is contoured, that is, the surface of the roll cover varies in elevation. The roll cover comprises a plurality of segments including low dusting millboard segments 5, a center highly rigidized compressed fiber segment 6 and outer highly rigidized compressed fiber segments 8. The millboard segments are intended to contact and support a glass sheet along the sheet's outer edges. The top surfaces 9 of the millboard segments 5 are also known as the pulling flats. In operation, a glass sheet preferably contacts only the pulling flats 9. The rigidized fiber segments 6, 8 mechanically support the millboard segments 5. Preferably, the fiber segments 6, 8 comprise the majority of the axial length of the roll cover so that any degradation of the millboard does not substantially impair the mechanical integrity of the roll cover. One skilled in the art would appreciate that the sizes and positions of the millboard and fiber segments depend on several factors, such as production conditions, machine configurations, etc.

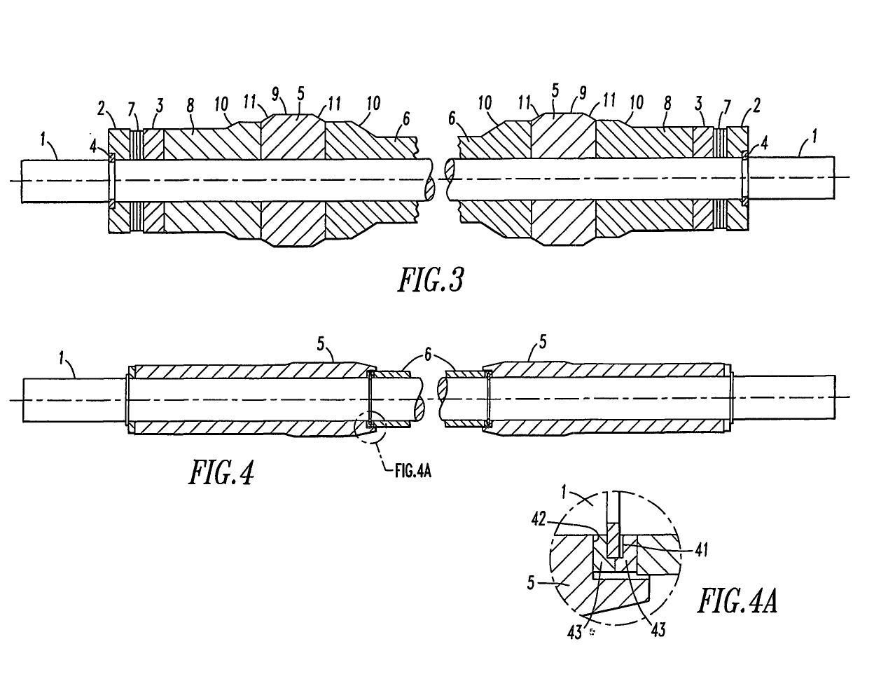

FIG. 3 shows an alternative embodiment of the present invention. The roll includes a shaft 1 and roll cover. The roll cover comprises a plurality of low dusting millboard segments 5, at least one center highly rigidized compressed fiber segment 6, and a plurality of outer highly rigidized compressed fiber segments 8. The fiber segments 6, 8 include shoulders 10 at the junction with the millboard segments 5. The shoulders 10 provide additional support for the millboard segments 5. Advantageously, the shoulders 10 remain below the level of the pulling flats 9. The millboard segments 5 may also include inclines 11 that substantially eliminate orthogonal edges on the millboard segments 5. Preferably, the incline 11 transitions into the shoulder 10. Most preferably, the incline transitions into the shoulder without a discontinuity, that is, in a continuous, seamless manner.

When constructing the roll cover on a mandrel, differences in cross-sectional areas of the center segment and the contacting portions can cause manufacturing problems. The center section often has a smaller cross-section than the contacting portion. In other words, for any given force applied axially along the mandrel, the pressure on the center section is much greater than on the contacting portion. An adequate pressure on the contacting portion could create sufficient pressure on the center section capable of crushing the center segment.

FIGS. 4 and 4a show a configuration designed to overcome this problem. The roll cover over the mandrel 1 comprises pulling flats 5 separated by a compressed center segment 6. The pulling flats comprise low dusting millboard segments. The center segment comprises a refractory material, such as a refractory fiber or millboard. Preferably, the surface of the center segment is sealed to reduce dusting. Compression rings 41 on either end of the center segment 6 maintain the segment in compression during manufacture and use of the roll cover. In one embodiment, the compression ring 41 comprises a snap ring adapted to fit into a recess 42 in the mandrel 1. The snap ring is intended to prevent movement of the center segment along the length of the mandrel. The recess 42 may include an insert 43 for adjusting the compressive force. Conveniently, the insert may consist of two pieces. Compression rings permit a center segment with lower diameter than otherwise while still avoiding crushing of the center segment. Compression rings also allow compression on the pulling flat to be tailored to the requirements of the pulling flats. In some cases, an end plate (not shown) of the roll need not exert so great a force on the pulling flats as would otherwise be necessary. This can reduce the need for a spring on the end plate and crushing of the various segments.

Obviously, numerous modifications and variations of the present invention are possible. Within the scope of the following claims, the invention may be practiced otherwise than as specifically described. While this invention has been described with respect to certain preferred embodiments, different variations, modifications, and additions to the invention will become evident to persons of ordinary skill in the art. All such modifications, variations, and additions are intended to be encompassed within the scope of this patent, which is limited only by the claims appended hereto.

1. A refractory roll cover for a pulling roll used in the production of glass sheet comprising:
a) a contacting segment adapted to contact the glass sheet, comprising a low dusting millboard; and
b) a rigid segment providing mechanical support for the contacting segment, comprising rigidized compressed fiber.

2. The roll cover of claim 1, wherein the millboard comprises clay and mica.

3. The roll cover of claim 1, wherein the rigid segment comprises a sealed surface, thereby reducing dusting of the rigid segment.

4. The roll cover of claim 1, wherein the rigid segment comprises a shoulder adjacent to the contacting segment, thereby improving mechanical support for the contacting segment.

5. The roll cover of claim 4, wherein the contacting segment comprises an inclined edge that transitions into the shoulder, whereby a discontinuity with the rigid segment is reduced.

6. The roll cover of claim 1, wherein the rigid segment is positioned between at least two contacting segments.

7. The roll cover of claim 1, wherein the contacting segment is positioned between at least two rigid segments.

8. The roll cover of claim 1, wherein at least two contacting segments separate the rigid segment and bound at least two additional rigid segments.

9. The roll cover of claim 1, wherein the contacting segment has a larger external diameter than the rigid segment, whereby the glass sheet avoids contact with the rigid segment.

10. (canceled)

11. The pulling roll of claim 15, wherein the rigid segment at least one end, and a compression ring adjacent to the end cooperates with the pulling roll to maintain compression on the rigid segment.

12. The roll cover of claim 15, wherein the rigid segment includes two ends, and a compression ring at each end of the rigid segment.

13. The roll cover of claim 11, wherein the compression ring comprises a split ring.

14. The roll cover of claim 12, wherein the rigid segment is positioned between at least two contacting segments.

15. A refractory pulling roll for the production of glass sheet comprising:
a) a roll cover comprising at least one contacting segment between a plurality of rigid segments, the contacting segment adapted to contact the glass sheet and comprising a low dusting millboard, and the rigid segments comprising rigidized compressed fiber and providing mechanical support for the contacting segment;
b) a plurality of end plates adjacent to ends of the roll cover; and
c) at least one compressive spring between at least one end plate and the roll cover, whereby a compressive force is exerted on the roll cover.

16. A refractory roll cover for a pulling roll used in the production of glass sheet comprising at least one contacting segment comprising a low dusting millboard, a plurality of rigid segments comprising rigidized compressed fiber, the rigid segment sandwiching and mechanically supporting the contacting segment, the contacting segment having a larger external diameter than the rigid segment, whereby the glass sheet avoids contact with the rigid segment.

17. The roll cover of claim 16, wherein the rigid segment comprises a shoulder adjacent to the contacting segment, thereby improving mechanical support for the contacting segment.

18. The roll cover of claim 17, wherein the contacting segment comprises an inclined edge that transitions into the shoulder, whereby a discontinuity with the rigid segment is reduced.
